(19) United States
(12) Patent Application Publication
(10) Pub. No.: US 2013/0016244 A1
(43) Pub. Date: Jan. 17, 2013

(54) IMAGE PROCESSING APARATUS AND METHOD, LEARNING APPARATUS AND METHOD, PROGRAM AND RECORDING MEDIUM

(71) Applicants: Noriaki TAKAHASHI, Tokyo (JP); Takahiro NAGANO, Kanagawa (JP)

(72) Inventors: Noriaki TAKAHASHI, Tokyo (JP); Takahiro NAGANO, Kanagawa (JP)

(21) Appl. No.: 13/546,561

(22) Filed: Jul. 11, 2012

(30) Foreign Application Priority Data
Jul. 14, 2011 (JP) 2011-155712

(51) Int. Cl. H04N 5/228

(52) U.S. Cl. 348/222.1; 348/E05.031

(57) ABSTRACT

There is provided an image processing apparatus including a calculation part calculating a prediction value of a target pixel in an image captured by an image capturing part capturing images using an image sensor configured by regularly arranging a plurality of pixels having a plurality of exposure times based on values of a plurality of other pixels different from the target pixel in exposure time and prediction coefficients corresponding to the respective other pixels; and a motion amount identifying part identifying a motion amount of the target pixel per unit time based on the calculated prediction value of the target pixel and a value of the target pixel.

### BACKGROUND

The present technology relates to an image processing apparatus and method, a learning apparatus and method, a program and a recording medium, and specifically relates to an image processing apparatus and method, a learning apparatus and method, a program and a recording medium capable of detecting motion of an image captured using an image sensor with different exposure times readily in high accuracy.

A solid state image sensor such as a CCD is employed as an image sensor used for image capturing apparatuses such as a video camera. However, the image capturing apparatuses using the solid state image sensor have a narrower dynamic range to quantity of incident light compared with silver salt-type image capturing apparatuses. The narrow dynamic range of the image capturing apparatuses can cause blocked up shadows (underexposure) or blown out highlights (overexposure) in the captured image.

In related art, it is known that some image capturing apparatus can extend its dynamic range by synthesizing the image with a wide dynamic range using plural image signals under different exposure quantities. Such past image capturing apparatus calculates a proper exposure quantity based on the image signal captured by the image sensor at the first frame and the exposure quantity at that time. Then, it performs the capturing by the image sensor at the second frame based on this under the proper exposure quantity or overexposure and underexposure. Next, it stores the image signals at the first and second frames in a memory, and synthesizes the image signals at the first and second frames stored in the memory to generate one image with an extended dynamic range.

A technology is also proposed in which the image sensor is constituted of two pixel groups into which all the pixels are divided, is capable of reading out video signals with different exposure times from the respective two pixel groups at one frame, and exchanges the exposure times for the two pixel groups every one frame (for example, see Japanese Patent Application Publication No. 2007-221423 which is hereinafter referred to as Patent Document 1).

Moreover, detection of a motion amount of the image is important, for example, when realizing an image stabilizing function for the video camera and the like. In the past, the motion amount was detected using chronologically sequential two images. When the motion amount is detected in this manner, configuring the different exposure times for the two images, for example, like Patent Document 1 can cause deterioration of detection accuracy.

Therefore, it is also proposed that plural pixel groups are integrated into one high-definition pixel group, and that plural times of the capturing are performed sequentially under different capturing conditions each time, for the purpose that the image capturing apparatus capable of extending the dynamic range enhances the detection accuracy of the motion amount (for example, see Japanese Patent Application Publication No. 2010-219940 which is hereinafter referred to as Patent Document 2).

According to the technology of Patent Document 2, the capturing can be performed with different exposure times for each pixel group of the image sensor by one-time exposure. For example, the pixel group of face A and the pixel group of face B can start the exposure simultaneously and the pixel group of face A can complete the exposure after the pixel group of face B completes the exposure.

### SUMMARY

However, the detection of the motion amount, for example, according to the technology of Patent Document 2, can still cause the deterioration of the detection accuracy when the target pixel moves toward the pixel different from itself in exposure time. The motion detection, for example, using a block matching method or a gradient method leads to difficulty of the difference extraction between the pixel exposed for a longer time and the pixel exposed for a shorter time.

The present technology is disclosed in view of aforementioned circumstances, and it is desirable to detect the motion of the image captured by the image sensor with different exposure times readily in high accuracy.

According to a first aspect of the present technology, there is provided an image processing apparatus including: a calculation part calculating a prediction value of a target pixel in an image captured by an image capturing part capturing images using an image sensor configured by regularly arranging a plurality of pixels having a plurality of exposure times based on values of a plurality of other pixels different from the target pixel in exposure time and prediction coefficients corresponding to the respective other pixels; and a motion amount identifying part identifying a motion amount of the target pixel per unit time based on the calculated prediction value of the target pixel and a value of the target pixel.

The image processing apparatus can further include a coefficient supply part supplying the prediction coefficients to the calculation part, wherein the coefficient supply part supplies the prediction coefficients corresponding to a preset pattern of motion to the calculation part, and the calculation part calculates the prediction value of the target pixel for each pattern of motion using a prediction expression based on the values of the plurality of other pixels and the prediction coefficients corresponding to the respective other pixels.

The motion amount identifying part can be configured to identify the motion amount of the target pixel per unit time based on a prediction error between the prediction value of the target pixel calculated for each preset pattern of motion and the value of the target pixel.

The prediction coefficients can be prediction coefficients previously learned by a learning apparatus, and the learning apparatus can include: a blur image generation part generating a blur image obtained by adding motion blur corresponding to a plurality of preset patterns of motion to the image captured by the image sensor; and a coefficient calculation part calculating, corresponding to the respective plurality of patterns of motion, the prediction coefficients for calculating the prediction value of the target pixel in the captured image based on the values of the plurality of other pixels different from the target pixel in exposure time.

According to the first aspect of the present technology, there is provided an image processing method including: calculating, with a calculation part, a prediction value of a target pixel in an image captured by an image capturing part capturing images using an image sensor configured by regularly arranging a plurality of pixels having a plurality of exposure times based on values of a plurality of other pixels different from the target pixel in exposure time and prediction coefficients corresponding to the respective other pixels; and identifying, with a motion amount identifying part, a motion amount of the target pixel per unit time based on the calculated prediction value of the target pixel and a value of the target pixel.

According to the first aspect of the present technology, there is provided a program causing a computer to function as an image processing apparatus including: a calculation part calculating a prediction value of a target pixel in an image captured by an image capturing part capturing images using an image sensor configured by regularly arranging a plurality of pixels having a plurality of exposure times based on values of a plurality of other pixels different from the target pixel in exposure time and prediction coefficients corresponding to the respective other pixels; and a motion amount identifying part identifying a motion amount of the target pixel per unit time based on the calculated prediction value of the target pixel and a value of the target pixel.

In the first aspect of the present technology, calculated is a prediction value of a target pixel in an image captured by an image capturing part capturing images using an image sensor configured by regularly arranging a plurality of pixels having a plurality of exposure times based on values of a plurality of other pixels different from the target pixel in exposure time and prediction coefficients corresponding to the respective other pixels; and identified is a motion amount of the target pixel per unit time based on the calculated prediction value of the target pixel and a value of the target pixel.

According to a second aspect of the present technology, there is provided a learning apparatus including: a blur image generation part generating a blur image obtained by adding motion blur corresponding to a plurality of preset patterns of motion to an image captured by an image capturing part capturing images using an image sensor configured by regularly arranging a plurality of pixels having a plurality of exposure times; and a coefficient calculation part calculating, corresponding to the respective plurality of patterns of motion, prediction coefficients for calculating a prediction value of the target pixel in the captured image based on values of a plurality of other pixels different from the target pixel in exposure time.

The learning apparatus can further include a prediction expression generation part generating a prediction expression for predicting a value of the target pixel based on the values of the plurality of other pixels in each blur image, wherein the coefficient calculation part calculates values of coefficients by which the values of the plurality of other pixels are multiplied in the generated prediction expression as the prediction coefficients.

The learning apparatus can further include a storage part storing the calculated prediction coefficients in association with the plurality of patterns of motion and positions of the plurality of other pixels.

According to the second aspect of the present technology, there is provided a learning method including: generating, with a blur image generation part, a blur image obtained by adding motion blur corresponding to a plurality of preset patterns of motion to an image captured by an image capturing part capturing images using an image sensor configured by regularly arranging a plurality of pixels having a plurality of exposure times; and calculating, with a coefficient calculation part, corresponding to the respective plurality of patterns of motion, prediction coefficients for calculating a prediction value of the target pixel in the captured image based on values of a plurality of other pixels different from the target pixel in exposure time.

According to the second aspect of the present technology, there is provided a program causing a computer to function as a learning apparatus including: a blur image generation part generating a blur image obtained by adding motion blur corresponding to a plurality of preset patterns of motion to an image captured by an image capturing part capturing images using an image sensor configured by regularly arranging a plurality of pixels having a plurality of exposure times; and a coefficient calculation part calculating, corresponding to the respective plurality of patterns of motion, prediction coefficients for calculating a prediction value of the target pixel in the captured image based on values of a plurality of other pixels different from the target pixel in exposure time.

In the second aspect of the present technology, generated is a blur image obtained by adding motion blur corresponding to a plurality of preset patterns of motion to an image captured by an image capturing part capturing images using an image sensor configured by regularly arranging a plurality of pixels having a plurality of exposure times; and calculated are, corresponding to the respective plurality of patterns of motion, prediction coefficients for calculating a prediction value of the target pixel in the captured image based on values of a plurality of other pixels different from the target pixel in exposure time.

According to the present technology, the motion of the image captured by the image sensor with different exposure times can be detected readily in high accuracy.

### BRIEF DESCRIPTION OF THE DRAWINGS

FIG. 1 is a block diagram illustrating an example of a configuration according to one embodiment of an image capturing control system to which the present technology is applied;

FIG. 2 is a diagram illustrating an example of a configuration of a light receiving plane of the image sensor in FIG. 1;

FIG. 3 is a diagram illustrating an example of a configuration of a target pixel;

FIG. 4 is a diagram illustrating another example of the configuration of the target pixel;

FIG. 5 is a diagram illustrating display in a polar coordinate system;

FIG. 6 is a block diagram illustrating a detailed example of a configuration of a coefficient calculation part in FIG. 1;

FIG. 7 is a block diagram illustrating a detailed example of a configuration of a motion amount detection part in FIG. 1;

FIG. 8 is a diagram for explaining selection of the minimum prediction error by a minimum value selection part in FIG. 7;

FIG. 9 is a flowchart illustrating an example of coefficient learning processes;

FIG. 10 is a flowchart illustrating an example of motion amount detection processes;

FIG. 11 is a diagram illustrating another example of the configuration of the light receiving plane of the image sensor in FIG. 1; and

FIG. 12 is a block diagram illustrating an example of a configuration of a personal computer.

### DETAILED DESCRIPTION OF THE EMBODIMENTS

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

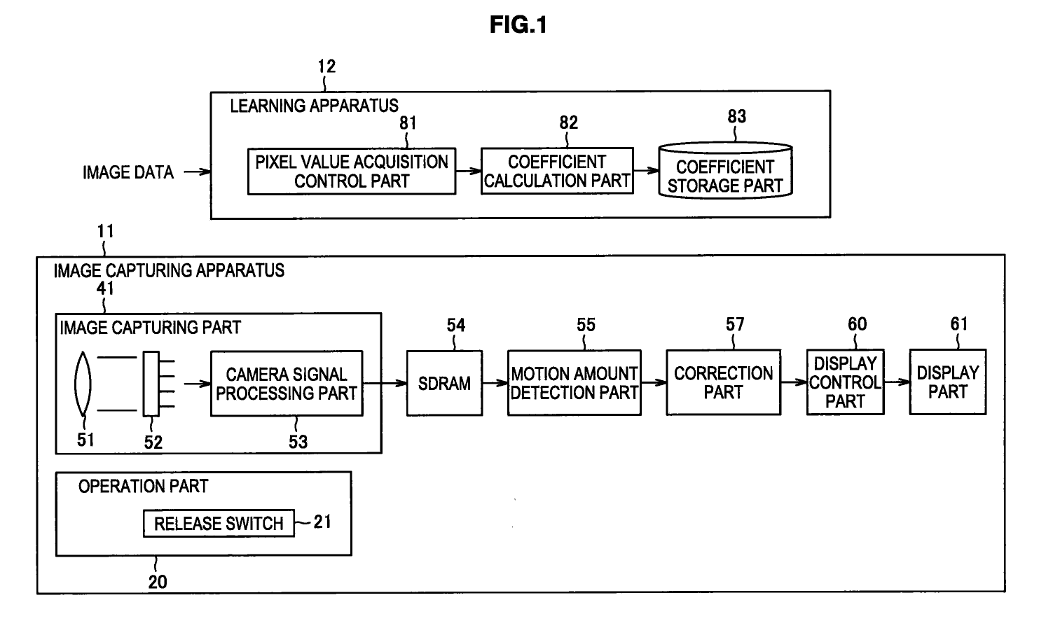

FIG. 1 is a block diagram illustrating an example of a configuration according to one embodiment of an image capturing control system to which the present technology is applied. This image capturing control system is configured to include an image capturing apparatus 11 constituted of, for example, a digital camera (digital still camera) or the like and a learning apparatus 12.

The image capturing apparatus 11 in FIG. 1 is configured to include an operation part 20, an image capturing part 41, an SDRAM (Synchronous Dynamic Random Access Memory) 54, a motion amount detection part 55, a correction part 57, a display control part 60 and a display part 61.

The operation part 20 is configured to include, for example, a release switch 21, a touch panel overlapping with the display part 61 mentioned below, and the like, and is operated by a user. The operation part 20 supplies an operation signal in response to the operation of the user to an appropriate block of the image capturing apparatus 11.

The image capturing part 41 captures an image of a subject by performing photoelectric conversion of received light incident thereinto, and supplies the resulting captured image to the SDRAM 54 to cause it to store (temporarily).

At this point, the image capturing part 41 is configured to include an imaging lens 51, an image sensor 52 and a camera signal processing part 53, and the imaging lens 51 forms the image of the subject on a light receiving plane of the image sensor 52.

The image sensor 52 is configured to include, for example, a CCD (Charge Coupled Devices) sensor, a CMOS (Complementary Metal Oxide Semiconductor) sensor, or the like. The image sensor 52 supplies the image (light) of the subject formed on its light receiving plane to the camera signal processing part 53 as an analog image signal by the photoelectronic conversion. In addition, a detailed example of a configuration of the image sensor 52 will be described below.

The camera signal processing part 53 performs, for example, gamma correction processing and/or white balance processing on the analog image signal supplied from the image sensor 52. After that, the camera signal processing part 53 performs A/D (Analog/Digital) conversion on the analog image signal, and supplies the resulting digital image signal (captured image) to the SDRAM 54 to cause it to store therein.

The SDRAM 54 stores the captured image supplied from the camera signal processing part 53 (image capturing part 41).

The motion amount detection part 55 reads out the captured image captured by the image capturing part 41 from the SDRAM 54. The motion amount detection part 55 detects a motion amount regarding the captured image read out from the SDRAM 54. The motion amount detection part 55 generates prediction expressions for predicting a value of a target pixel using values of pixels around the target pixel and coefficients stored in a coefficient storage part 83 of the learning apparatus 12 mentioned below, and detects the motion amount based on an error (prediction error) between the prediction value and an observed value of the target pixel.

The correction part 57 corrects the captured image supplied from the motion amount detection part 55 based on the motion amount of the captured image supplied from the same motion amount detection part 55, and supplies the captured image after the correction to the display control part 60.

The display control part 60 supplies the captured image supplied from the correction part 57 to the display part 61 to cause it to display.

According to the control of the display control part 60, the display part 61 displays the captured image and the like. For example, an LCD (Liquid Crystal Display) or the like can be employed as the display part 61.

The learning apparatus 12 in FIG. 1 is configured to include a pixel value acquisition control part 81, a coefficient calculation part 82 and the coefficient storage part 83.

The pixel value acquisition control part 81 controls acquisition of values of predetermined pixels in the image data inputted into the learning apparatus 12.

The coefficient calculation part 82 calculates coefficients regarding motion prediction mentioned below.

The coefficient storage part 83 stores the coefficients calculated by the coefficient calculation part 82 and supplies the coefficients to the image capturing apparatus 11 as needed.

The learning apparatus 12 is configured to learn the coefficients used for the prediction expressions for predicting the pixel value as mentioned below, for example, receiving data of a still image (image data) captured by the image capturing apparatus 11.

The pixel value acquisition control part 81 acquires the pixel value of the target pixel and ones around the target pixel in the image data supplied to the learning apparatus 12. As mentioned below, images having motion blur corresponding to a plurality of patterns of motion are generated. Then, based on the generated images, the prediction expressions, each corresponding to each motion, are generated. The values of the coefficients used for the prediction expression are calculated, for example, using a least square method or the like. These constitute the learning of the coefficients by the learning apparatus 12.

The coefficients obtained by the learning are stored in the coefficient storage part 83 and supplied to the motion amount detection part 55 of the image capturing apparatus 11.

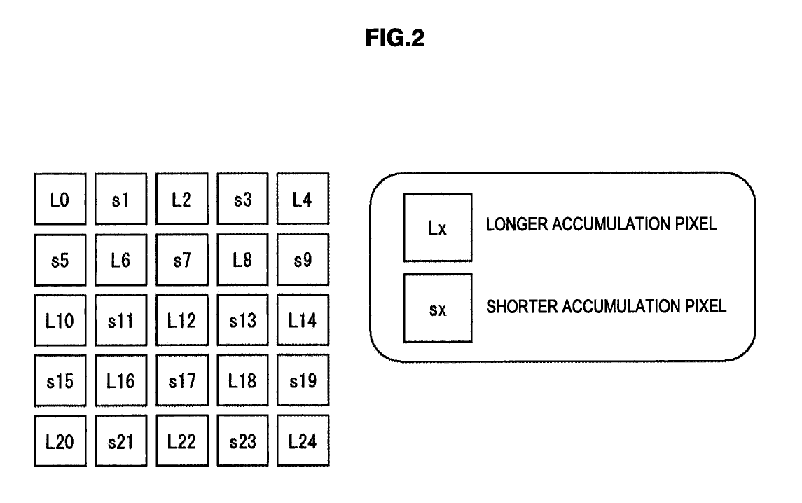

FIG. 2 is a diagram illustrating a detailed example of a configuration of the image sensor 52 in FIG. 1 as an example of a configuration of the light receiving plane. As illustrated in the figure, pixels with a longer exposure time and pixels with a shorter exposure time are regularly arranged in the imaging plane of the image sensor. Herein, the pixels with the longer exposure time are referred to as longer accumulation pixels on the basis that they accumulate charge obtained by the photoelectric conversion for a longer time, and represented by a symbol ‘Lx’ in the figure, where x as a suffix denotes a natural number. Also, the pixels with the shorter exposure time are referred to as shorter accumulation pixels on the basis that they accumulate charge obtained by the photoelectric conversion for a shorter time, and represented by a symbol ‘sx’ in the figure, where x as a suffix denotes a natural number.

In the example of FIG. 2, 25 (5×5) pixels are arranged into a square shape, and the longer accumulation pixels and the shorter accumulation pixels are arranged alternately therein. In this example, 13 longer accumulation pixels and 12 shorter accumulation pixels are arranged. Although the number of the pixels arranged in the image sensor 52 is 25 for simplicity, more pixels are arranged practically.

The image capturing apparatus 11 is configured to capture images with a wide dynamic range by using the image sensor 52 as illustrated in FIG. 2.

Next, the learning of the coefficients by the learning apparatus 12 is described in detail.

For example, image data of a still image captured by the image sensor 52 as illustrated in FIG. 2 as image data for the learning is prepared, and a target pixel in the image represented by the image data is configured.

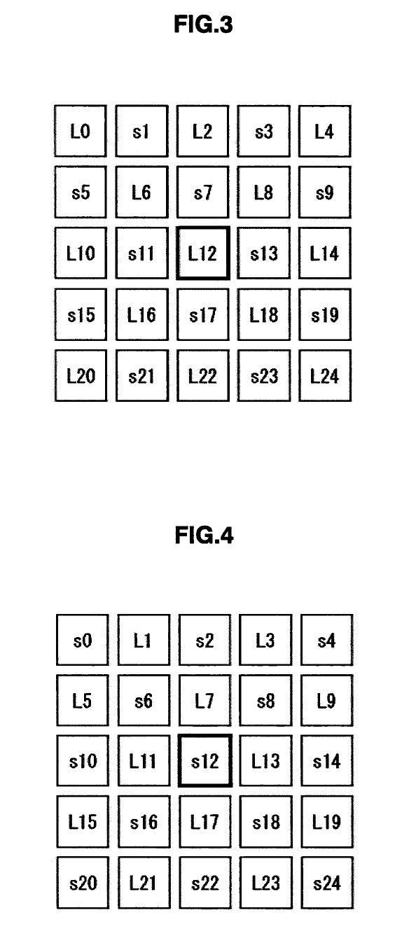

For example, a pixel L12, which is the pixel indicated by the thick-bordered box, illustrated in FIG. 3 is configured as the target pixel. In this case, it is expected that the pixel L12, which is the target pixel in the image data, has a pixel value obtained corresponding to charge accumulated in the pixel L12 as a longer accumulation pixel constituting the image sensor 52.

Herein, for example, when it is assumed that the target pixel moves by a motion amount mx in a horizontal direction and a motion amount my in a vertical direction, an image with motion blur (referred to as a blur image) obtained corresponding to the motion amounts is to be generated. A motion amount (mx, my) is defined as a vector representing a distance by which the subject moves in a unit time in the horizontal direction (x axis direction) and the vertical direction (y axis direction) in pixel numbers.

When the subject moves during exposure of pixels in the image sensor, light corresponding to one pixel in the still image of the subject is accumulated in plural pixels and thus the motion blur arises. Meanwhile, pixel values of the blur image can be generated, for example, by displacing the individual pixels in the still image according to the motion amount (mx, my) in the horizontal or vertical direction, adding the pixel values obtained by the displacement and the original pixel values to normalize, and the like. In addition, when generating the pixel values of the blur image, it is considered that the image sensor illustrated in FIG. 3 includes the longer accumulation pixels and the shorter accumulation pixels. That is, the pixel values are generated, taking into account of a speed specified corresponding to the motion amount and exposure times for the individual pixels.

For example, it is assumed that there are 5 motions in the horizontal direction and 5 motions in the vertical direction, and thus, 25 motion amounts (mx, my) (25 patterns) totally. For example, the motion amounts such as (−2, −2), (−2, −1), . . . , and (2, 2) can be assumed. Corresponding to these plural patterns of motion, the respective blur images are generated.

In the learning of the coefficients by the learning apparatus 12, at first, the blur images corresponding to the plural patterns of motion are generated as above.

After obtaining the blur images as mentioned above, a prediction expression is generated for predicting the pixel value of the pixel L12 as the longer accumulation pixel based on a pixel s1, pixel s3, . . . , and pixel s23 as the shorter accumulation pixels. In this case, Equation (1) is generated as the prediction expression for predicting the pixel value of the pixel L12 based on the pixel values of the 12 shorter accumulation pixels.

$$\begin{matrix}[ Expression 1 ] & \\ {L}_{12} = {\sum }_{k = 0}^{11} {ω}_{s \to L , mx , my , 2 k + 1} * {s}_{2 k + 1} + {e}_{s \to L , mx , my , L 12} & ( 1 )\end{matrix}$$

Herein, the coefficients in Equation (1) are represented by Equation (2).

[Expression 2]

ω_{s→L, mx, my, 2k+1}=ω (2)

The coefficients w in Equation (1) represent the coefficients for calculating the pixel value of the longer accumulation pixel based on the pixel values of the shorter accumulation pixels when a motion amount (mx, my) is given, that is, the coefficients by which the pixel values of the shorter accumulation pixels whose suffixes are 2k+1, where k is an integer of 0 to 11, are multiplied. In other words, Equation (1) is for predicting the target pixel value by calculating the value of the pixel L12 using a linear expression for the total sum of the individual values obtained by multiplication of taps by the coefficients ω, where the taps are the values of the 12 shorter accumulation pixels existing around the pixel L12.

Moreover, Equation (3) represents the rightmost term on the right hand side of Equation (1).

[Expression 3]

e_{s→L, mx, my}=e (3)

The term e on the right hand side of Equation (1) represents a prediction error in calculating (predicting) the pixel value of the longer accumulation pixel L12 based on the pixel values of the shorter accumulation pixels when a motion amount (mx, my) is given.

Generating sets of Equation (1) and Equation (3) as samples from a plurality of image data inputted into the learning apparatus 12 enables calculation of the coefficients for which the prediction error is at its minimum in Equation (1), for example, using a least square method. Thus, the coefficients can be calculated for the multiplication of the pixel s1, pixel s3, . . . , and pixel s23, respectively. For example, 12 coefficients are calculated for one motion amount (mx, my). And similarly, sets of the 12 coefficients are calculated, for example, for 25 motion amounts (mx, my), respectively.

By doing this, obtained are the coefficients for calculating the pixel value of the longer accumulation pixel based on the pixel values of the shorter accumulation pixels, that is, the sets of the coefficients, for example, corresponding to the 25 motion amounts (mx, my).

Next, in the same manner as in the above-mentioned case, coefficients for predicting a pixel value of a shorter accumulation pixel based on pixel values of longer accumulation pixels are evaluated.

That is, image data of a still image, for example, captured by the image sensor 52 as illustrated in FIG. 4 as image data for the learning is prepared, and a target pixel in the image represented by the image data is configured.

For example, a pixel s12, which is the pixel indicated by the thick-bordered box, illustrated in FIG. 4 is configured as the target pixel. In this case, it is expected that the pixel s12, which is the target pixel in the image data, has a pixel value obtained corresponding to charge accumulated in the pixel s12 as a shorter accumulation pixel constituting the image sensor 52.

Then, as in the above-mentioned case, the blur images corresponding to the plural patterns of motion are generated.

After obtaining the blur images, a prediction expression is generated for predicting a pixel value of the pixel s12 as the shorter accumulation pixel based on a pixel L1, pixel L3, . . . , and pixel L23 as the longer accumulation pixels. In this case, Equation (4) is generated as the prediction expression for predicting the pixel value of the pixel s12 based on the pixel values of the 12 longer accumulation pixels.

$$\begin{matrix}[ Expression 4 ] & \\ {s}_{12} = {\sum }_{k = 0}^{11} {ω}_{L \to s , mx , my , 2 k + 1} * {L}_{2 k + 1} + {e}_{L \to s , mx , my} & ( 4 )\end{matrix}$$

Herein, the coefficients in Equation (4) are represented by Equation (5).

[Expression 5]

ω_{L→s, mx, my, 2k+1}=ω (5)

The coefficients ω in Equation (4) represent the coefficients for calculating the pixel value of the shorter accumulation pixel based on the pixel values of the longer accumulation pixels when a motion amount (mx, my) is given, that is, the coefficients by which the pixel values of the longer accumulation pixels whose suffixes are 2k+1, where k is an integer of 0 to 11, are multiplied. In other words, Equation (4) is for predicting the target pixel value by calculating the value of the pixel s12 using a linear expression for the total sum of the individual values obtained by multiplication of taps by the coefficients ω, where the taps are the values of the 12 longer accumulation pixels existing around the pixel s12.

Moreover, Equation (6) represents the rightmost term on the right hand side of Equation (4).

[Expression 6]

e_{L→s, mx, my}=e (6)

The term e in Equation (4) represents a prediction error in calculating the pixel value of the shorter accumulation pixel s12 based on the pixel values of the longer accumulation pixels when a motion amount (mx, my) is given.

The coefficients for which the prediction error is at its minimum in Equation (4), for example, using a least square method can be calculated. Thus, the coefficients are calculated for the multiplication of the pixel L1, pixel L3, . . . , and pixel L23, respectively. For example, 12 coefficients are calculated for one motion amount (mx, my). And similarly, sets of the 12 coefficients are calculated, for example, for 25 motion amounts (mx, my), respectively.

By doing this, obtained are the coefficients for calculating the pixel value of the shorter accumulation pixel based on the pixel values of the longer accumulation pixels, that is, the sets of the coefficients, for example, corresponding to the 25 motion amounts (mx, my).

As mentioned above, detection of the motion amounts by the motion amount detection part 55 is performed using the coefficients learned by the learning apparatus 12 (coefficients stored in the coefficient storage part 83). Next, the detection of the motion amounts by the motion amount detection part 55 is described in detail.

A pixel for which the motion amounts are to be detected is configured as the target pixel in image data, for example, supplied from the SDRAM 54. Then, the prediction expression for predicting the value of the target pixel is generated based on the values of the pixels around the target pixel using the coefficients learned by the learning apparatus 12. Herein, the prediction expression is generated for each of the plural patterns of motion.

When the target pixel is the longer accumulation pixel, Equation (7) as the prediction expression is generated, for example, for each of the 25 motion amounts (mx, my).

$$\begin{matrix}[ Expression 7 ] & \\ {L}_{12 , mx , my}^{′} = {\sum }_{k = 0}^{11} {ω}_{s \to L , mx , my , 2 k + 1} * {s}_{2 k + 1} & ( 7 )\end{matrix}$$

When L₁₂ represents an observed value of the target pixel in the image data supplied from the SDRAM 54, Equation (8) represents the prediction error for Equation (7).

[Expression 8]

e_{s→L, mx, my}=L₁₂−L_{12, mx, my}′ (8)

As mentioned above, since the prediction expression of Equation (7) is generated for each of the plural patterns of motion, the prediction error represented by Equation (8) is obtained also for each of the plural patterns of motion. For example, 25 prediction errors are obtained.

Accordingly, when the prediction error whose absolute value is at its minimum is selected, for example, from among the 25 prediction errors, the motion amount corresponding to the selected one is considered closest to the motion of the target pixel in the image data supplied from the SDRAM 54. The motion amount detection part 55 selects the prediction error whose absolute value is at its minimum, for example, from among the 25 prediction errors to output the motion amount (mx, my) corresponding to this one as the detection result.

Or the motion amount detection part 55 may calculate the motion amounts for the respective plural pixels adjacent to the target pixel similarly, and output the motion amount obtained by normalization of these motion amounts or the motion amount decided by majority as the detection result.

On the other hand, when the target pixel is the shorter accumulation pixel,

Equation (9) as the prediction expression is generated for each of the 25 motion amounts (mx, my).

$$\begin{matrix}[ Expression 9 ] & \\ {s}_{12 , mx , my}^{′} = {\sum }_{k = 0}^{11} {ω}_{L \to s , mx , my , 2 k + 1} * {L}_{2 k + 1} & ( 9 )\end{matrix}$$

Then, same as for Equation (8) in the case of the longer accumulation pixel, the calculation of the prediction error for Equation (9) enables the detection of the motion amount which is considered closest to the motion of target pixel in the image data supplied from the SDRAM 54

In the above argument, although an example in the case that the 25 motion amounts (mx, my) are assumed is described, the patterns of motion are, of course, not limited to those.

Thus, the motion amount is detected.

In the above argument, although an example in the case that the (x, y) coordinate system, that is, orthogonal coordinate system is used for identifying the pixel position is described, the (r, θ) coordinate system as a polar coordinate system can be used.

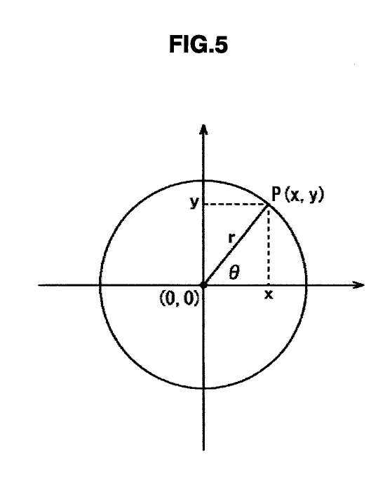

When the polar coordinate system is used, a desired pixel position can be represented by a radius r of a circle whose center is identical to the origin (0, 0) in the orthogonal coordinate system and the angle 0 formed by the line connecting a point on the circumference of the circle and the origin and an X axis as illustrated in FIG. 5. In other words, the orthogonal coordinate system and the polar coordinate system can be converted to each other using Equation (10) and Equation (11).

$$\begin{matrix}[ Expression 10 ] & \\ ( \begin{matrix}x \\ y\end{matrix} ) = ( \begin{matrix}r \cdot cos θ \\ r \cdot sin θ\end{matrix} ) & ( 10 ) \\ [ Expression 11 ] & \\ ( \begin{matrix}r \\ θ\end{matrix} ) = ( \begin{matrix}\sqrt{{x}^{2} + {y}^{2}} \\ {tan}^{- 1} ( \frac{y}{x} )\end{matrix} ) & ( 11 )\end{matrix}$$

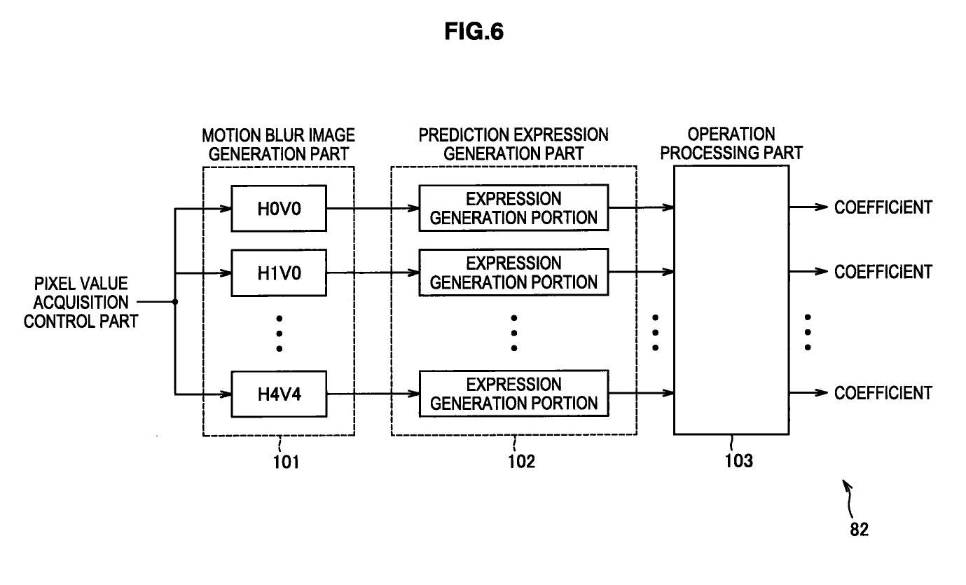

FIG. 6 is a block diagram illustrating a detailed example of a configuration of the coefficient calculation part 82 in FIG. 1. As illustrated in the figure, the coefficient calculation part 82 is configured to include a motion blur image generation part 101, a prediction expression generation part 102 and an operation processing part 103.

For example, when it is assumed that the target pixel moves by a motion amount mx in the horizontal direction and a motion amount my in the vertical direction, the motion blur image generation part 101 generates a blur image obtained corresponding to the motion amounts. Herein, the motion blur image generation part 101 is configured to include a plurality of image generation portions inside, and in this example, configured to include an image generation portion of H0V0, an image generation portion of H1V1, . . . , and an image generation portion of H4V4.

As mentioned above, the motion blur image generation part 101 generates blur images corresponding to the plural patterns of motion. For example, it is assumed that there are 5 motions in the horizontal direction and 5 motions in the vertical direction, and thus, 25 motion amounts (mx, my) (25 patterns) totally to generate the blur images. For example, the motion amounts such as (−2, −2), (−2, −1), . . . , and (2, 2) can be assumed. Corresponding to the motions in the horizontal direction (H) and the motions in the vertical direction (V) in these plural patterns of motion, the image generation portion of H0V0, the image generation portion of H1V1, . . . , and the image generation portion of H4V4 generate the blur images, respectively.

The prediction expression generation part 102 generates the prediction expressions, for example, as illustrated in Equation (1) or Equation (4). In the prediction expression generation part 102, expression generation portions are provided to generate the prediction expressions corresponding to the respective blur images generated by the motion blur image generation part 101. The expression generation portions of the prediction expression generation part 102 generate the respective prediction expressions, for example, corresponding to the 25 motion amounts (mx, my).

The operation processing part 103 calculates the coefficients for which the prediction error is at its minimum in Equation (1) or Equation (4), for example, using a least square method. Thereby, the coefficients are calculated, for example, for the multiplication of the pixel s1, pixel s3, . . . , and pixel s23 in Equation (1), respectively. In other words, the coefficients are calculated corresponding to the positions of the plural pixels as the taps, respectively. For example, the 12 coefficients are calculated for one motion amount (mx, my). And similarly, the sets of the 12 coefficients are calculated, for example, for the respective 25 motion amounts (mx, my).

Thus, the coefficients calculated by the operation processing part 103 are to be stored in the coefficient storage part 83. In other words, the coefficient storage part 83 stores the coefficients calculated by the operation processing part 103 in association with the plural patterns of motion (for example, 25 motion amounts) and the positions of the pixels as the taps.

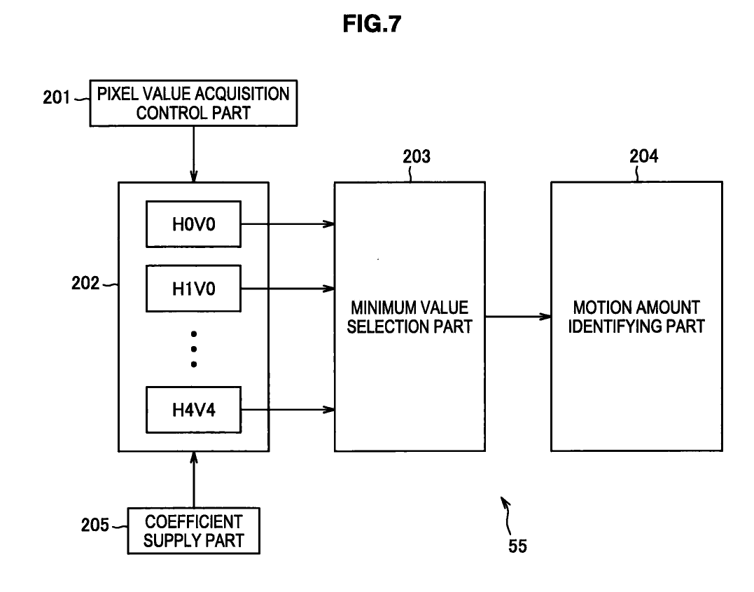

FIG. 7 is a block diagram illustrating a detailed example of a configuration of the motion amount detection part 55 in FIG. 1.

In this example, the motion amount detection part 55 is configured to include a pixel value acquisition control part 201, a prediction error calculation part 202, a minimum value selection part 203, a motion amount identifying part 204 and a coefficient supply part 205.

The pixel value acquisition control part 201 controls acquisition of the values of the predetermined pixels in the image data inputted into the motion amount detection part 55.

The prediction error calculation part 202 calculates the prediction errors as illustrated in Equation (6) or Equation (8). Herein, the prediction error calculation part 202 is configured to include a plurality of calculation portions inside, and in this example, configured to include a calculation portion of H0V0, a calculation portion of H1V1, . . . , and a calculation portion of H4V4.

As mentioned above, the prediction error calculation part 202 calculates the 25 prediction errors obtained corresponding to the respective plural patterns of motion. Corresponding to the motions in the horizontal direction (H) and the motions in the vertical direction (V) in these plural patterns of motion, the calculation part of H0V0, the calculation part of H1V1, . . . , and the calculation part of H4V4 calculate the prediction errors, respectively.

The coefficient supply part 205 is configured to acquire the coefficients stored in the coefficient storage part 83 of the learning apparatus 12 and supply the coefficients to the prediction error calculation part 202 as needed. For example, when the prediction error is calculated in the case that the motion amount is (−2, −2), for example, the 12 coefficients are supplied corresponding to the motion amount. Moreover, when the prediction error is calculated in the case that the motion amount is (−2, −1), for example, the 12 coefficients are supplied corresponding to the motion amount. Thus, the sets of the coefficients are supplied, for example, corresponding to the respective 25 patterns.

The minimum value selection part 203 selects the prediction error whose absolute value is at its minimum from among the plural ones calculated by the prediction error calculation part 202. As mentioned above, the motion amount corresponding to the selected prediction error is considered closest to the motion of the target pixel in the image data supplied from the SDRAM 54.

The motion amount identifying part 204 identifies the motion amount corresponding to the prediction error selected by the minimum value selection part 203 to output the motion amount.

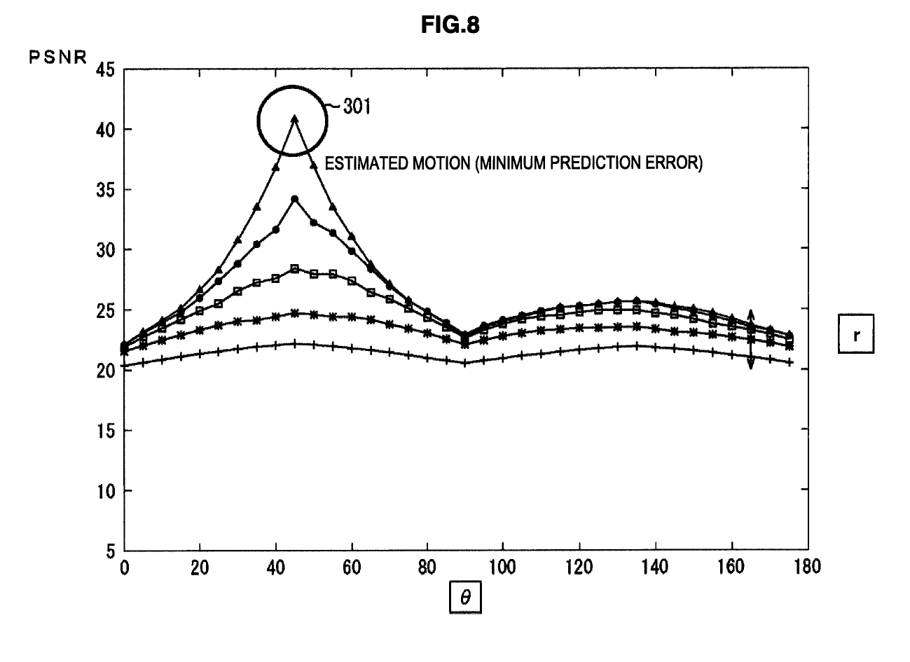

FIG. 8 is a diagram for explaining the selection of the minimum prediction error by the minimum value selection part 203. In the figure, the vertical axis represents the reciprocal number of the prediction error (referred to as PSNR), the horizontal axis represents θ, and variations of the values of PSNR corresponding to the 5 values of r are plotted. In the figure, the variations of the values of PSNR are plotted with different symbols corresponding to the values of r, respectively.

In the example in the figure, the value of PSNR is the highest at the point surrounded by a circle 301 (a triangle in the figure), and the prediction error is at its minimum at this point. Accordingly, the motion amount which is a motion amount represented by (r, θ) in the polar coordinate system, and for which the value of r is the value corresponding to the point plotted with the triangle in the figure and the value of θ is approximately 45, is considered closest to the motion of the target pixel in the image data supplied from the SDRAM 54.

Or the motion amounts may be calculated for the respective plural pixels adjacent to the target pixels similarly to output the motion amount obtained by normalization of these motion amounts or the motion amount decided by majority as the detection result.

For example, the detection of the motion amount using the past technology tends to cause deterioration of detection accuracy, when the target pixel moves toward the pixel different from itself in exposure time. Moreover, the motion detection, for example, using a block matching method or a gradient method leads to difficulty of the difference extraction between the pixel exposed for a longer time and the pixel exposed for a shorter time.

In contrast, according to the present technology, even when the target pixel moves toward the pixel different from itself in exposure time, the deterioration of the detection accuracy does not necessarily arise. Employing the present technology, there is no need for the extraction of the difference between chronologically sequential frames, and therefore, the motion can be detected readily and quickly.

Hence, according to the present technology, the motion of the image captured by the image sensor with different exposure times can be detected readily in high accuracy.

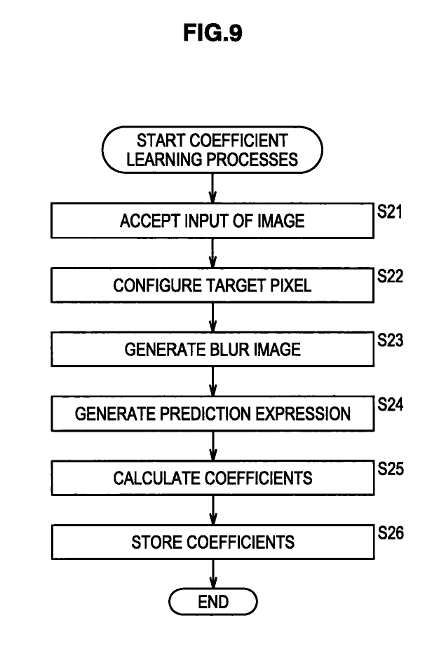

Next, an example of coefficient learning processes by the learning apparatus 12 in FIG. 1 are described, referring to a flowchart in FIG. 9.

In step S21, input of the image is accepted.

In step S22, the target pixel in the image whose input is accepted in the process of step S21 is configured.

In step S23, the motion blur image generation part 101 generates the blur image obtained corresponding to the motion amount, for example, when it is assumed that the target pixel moves by the motion amount mx in the horizontal direction and the motion amount my in the vertical direction.

At this stage, the motion blur image generation part 101 generates the blur images corresponding to the plural patterns of motion as mentioned above. For example, assuming that there are 5 motions in the horizontal direction and 5 motions in the vertical direction, and thus, 25 motion amounts (mx, my) (25 patterns) totally, the blur images are generated. For example, the motion amounts such as (−2, −2), (−2, −1), . . . , and (2, 2) can be assumed. Corresponding to the motions in the horizontal direction (H) and the motions in the vertical direction (V) in these plural patterns of motion, the image generation portion of H0V0, the image generation portion of H1V1, . . . , and the image generation portion of H4V4 generate the respective blur images.

In step S24, the prediction expression generation part 102 generates the prediction expressions, for example, as indicated in Equation (1) or Equation (4). At this stage, the expression generation portions of the prediction expression generation part 102 generate the respective prediction expressions, for example, corresponding to the 25 motion amounts (mx, my).

In step S25, the operation processing part 103 calculates the coefficients in the prediction expressions generated in step S24. At this stage, the operation processing part 103 calculates the coefficients for which the prediction error is at its minimum in Equation (1) or Equation (4), for example, using a least square method. Thereby, the coefficients are calculated, for example, for the multiplication of the pixel s1, pixel s3, . . . , and pixel s23 in Equation (1), respectively. For example, the 12 coefficients are calculated for one motion amount (mx, my). And similarly, the sets of the 12 coefficients are calculated, for example, for the respective 25 motion amounts (mx, my).

In step S26, the coefficient storage part 83 stores the coefficients calculated in the process of step S25.

Thus, the coefficient learning processes have been performed.

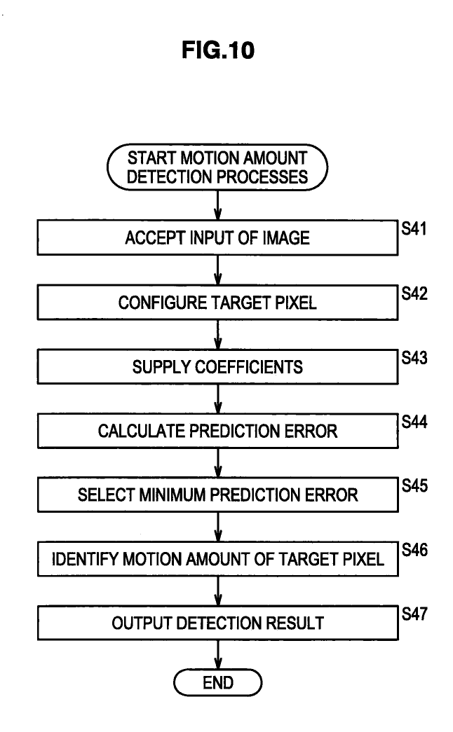

Next, an example of the motion amount detection processes by the motion amount detection part 55 in FIG. 7 are described, referring to a flowchart in FIG. 10. Prior to these processes, it is assumed that the coefficient supply part 205 acquires the coefficients stored in the coefficient storage part 83 of the learning apparatus 12.

In step S41, input of the image is accepted.

In step S42, the target pixel in the image whose input is accepted in the process in step S41 is configured.

In step S43, the coefficient supply part 205 supplies the coefficients to the prediction error calculation part 202 as needed. In other words, the coefficients, for example, corresponding to the respective 25 patterns are supplied for the operation of the prediction error in the process of step S44 mentioned below.

In step S44, the prediction error calculation part 202 calculates the prediction error as indicated in Equation (6) or Equation (8). At this stage, the prediction error calculation part 202 calculates the 25 prediction errors corresponding to the respective plural patterns of motion as mentioned above.

Corresponding to the motions of horizontal direction (H) and the motions of vertical direction (V) in these plural patterns of motion, the calculation portion of H0V0, the calculation portion of H1V1, . . . , and the calculation portion of H4V4 calculate the prediction errors, respectively, and at this stage, the coefficients supplied in the process of step S43 are used, respectively.

In step S45, the minimum value selection part 203 selects the prediction error whose absolute value is at its minimum from among the plural ones calculated in the process of step S44.

In step S46, the motion amount identifying part 204 identifies the motion amount corresponding to the prediction error selected in the process of step S45 as the motion amount of the target pixel.

In step S47, the motion amount identifying part 204 outputs the motion amount identified in the process of step S46 as the detection result.

Thus, the motion amount detection processes have been performed.

Incidentally, although FIG. 2 to FIG. 4 illustrate the example in which the longer accumulation pixels and the shorter accumulation pixels are arranged in the imaging plane of the image sensor 52 one by one alternately, the longer accumulation pixels and the shorter accumulation pixels are not necessarily arranged one by one alternately.

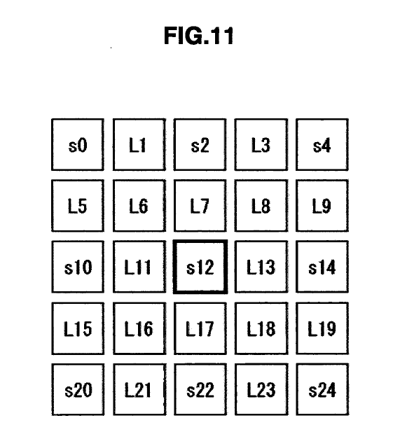

For example, even when the light receiving plane of the image sensor 52 is configured as illustrate in FIG. 11, the present technology is, of course, applicable. FIG. 11 is a diagram illustrating a detailed example of the configuration of the image sensor 52 in FIG. 1 as another example of the configuration of the light receiving plane. In the example in the figure, the shorter accumulation pixels are arranged every two rows. Also in the figure, the longer accumulation pixels are represented by a symbol ‘Lx’ in the figure, where x as a suffix denotes a natural number and the shorter accumulation pixels are represented by a symbol ‘sx’ in the figure, where x as a suffix denotes a natural number.

Namely, in the configuration in FIG. 11, as to the light receiving plane of the image sensor 52 constituted of the pixels in 5 rows and 5 columns, the shorter accumulation pixels are arranged in the first row thereof but the shorter accumulation pixels are not arranged in the second row thereof. Moreover, the shorter accumulation pixels are arranged in the third row thereof but the shorter accumulation pixels are not arranged in the fourth row thereof. The shorter accumulation pixels are arranged in the lowermost row thereof.

For example, when the target pixel is configured as the pixel indicated by s12 in FIG. 11, Equation (12) can be used as the prediction expression in place of Equation (9).

$$\begin{matrix}[ Expression 12 ] & \\ {s}_{12}^{′} = {\sum }_{t = 1 , 3 , 5 , 6 , 8 , 9 , 11 , 13 , 15 , 16 , 17 , 18 , 19 , 21 , 23} {ω}_{L \to s , mx , my , t} * {L}_{t} & ( 12 )\end{matrix}$$

In addition, the numerical values indicated as ‘t=1, 3, 5, . . . , 23’ in Equation (12) represent the tap numbers, and the suffix of each of the longer accumulation pixels in FIG. 11 is designated corresponding to each value of t.

Thus, for example as illustrated in FIG. 11, even when using the image sensor 52 in which the longer accumulation pixels and the shorter accumulation pixels are arranged unevenly, the present technology can be applicable.

The series of processes described above can be realized by hardware or software. When the series of processes is executed by the software, a program forming the software is installed in a computer embedded in dedicated hardware and a general-purpose personal computer 700 illustrated in FIG. 11 in which various programs can be installed and various functions can be executed, through a network or a recording medium.

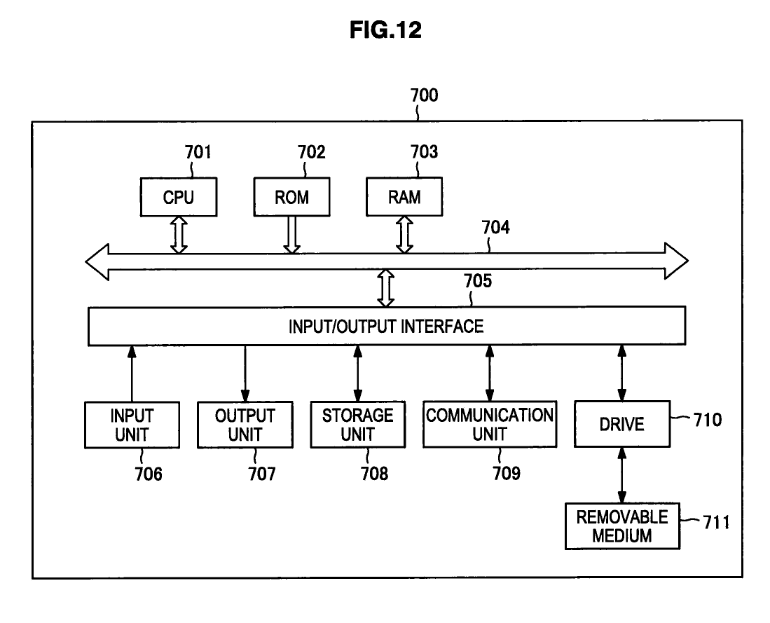

In FIG. 12, a central processing unit (CPU) 701 executes various processes according to a program stored in a read only memory (ROM) 702 or a program loaded from a storage unit 708 to a random access memory (RAM) 703. In the RAM 703, data that is necessary for executing the various processes by the CPU 701 is appropriately stored.

The CPU 701, the ROM 702, and the RAM 703 are connected mutually by a bus 704. Also, an input/output interface 705 is connected to the bus 704.

An input unit 706 that includes a keyboard and a mouse, an output unit 707 that includes a display composed of a liquid crystal display (LCD) and a speaker, a storage unit 708 that is configured using a hard disk, and a communication unit 709 that is configured using a modem and a network interface card such as a LAN card are connected to the input/output interface 705. The communication unit 709 executes communication processing through a network including the Internet.

A drive 710 is connected to the input/output interface 705 according to necessity, a removable medium 711 such as a magnetic disk, an optical disc, a magneto optical disc, or a semiconductor memory are appropriately mounted, and a computer program that is read from the removable medium 711 is installed in the storage unit 708 according to necessity.

When the series of processes is executed by the software, a program forming the software is installed through the network such as the Internet or a recording medium composed of the removable medium 711.

The recording medium may be configured using the removable medium 711 illustrated in FIG. 12 that is composed of a magnetic disk (including a floppy disk (registered trademark)), an optical disc (including a compact disc-read only memory (CD-ROM) and a digital versatile disc (DVD)), a magneto optical disc (including a mini-disc (MD) (registered trademark)), or a semiconductor memory, which is distributed to provide a program to a user and has a recorded program, different from a device body, and may be configured using a hard disk that is included in the ROM 702 provided to the user in a state embedded in the device body in advance having a recorded program or the storage unit 708.

In the present disclosure, the series of processes includes a process that is executed in the order described, but the process is not necessarily executed temporally and can be executed in parallel or individually.

It should be understood by those skilled in the art that various modifications, combinations, sub-combinations and alterations may occur depending on design requirements and other factors insofar as they are within the scope of the appended claims or the equivalents thereof.

Additionally, the present technology may also be configured as below.
(1) An image processing apparatus comprising:

a calculation part calculating a prediction value of a target pixel in an image captured by an image capturing part capturing images using an image sensor configured by regularly arranging a plurality of pixels having a plurality of exposure times based on values of a plurality of other pixels different from the target pixel in exposure time and prediction coefficients corresponding to the respective other pixels; and

a motion amount identifying part identifying a motion amount of the target pixel per unit time based on the calculated prediction value of the target pixel and a value of the target pixel.
(2) The image processing apparatus according to (1), further comprising:

a coefficient supply part supplying the prediction coefficients to the calculation part, wherein

the coefficient supply part supplies the prediction coefficients corresponding to a preset pattern of motion to the calculation part, and

the calculation part calculates the prediction value of the target pixel for each pattern of motion using a prediction expression based on the values of the plurality of other pixels and the prediction coefficients corresponding to the respective other pixels.
(3) The image processing apparatus according to (1) or (2), wherein

the motion amount identifying part identifies the motion amount of the target pixel per unit time based on a prediction error between the prediction value of the target pixel calculated for each preset pattern of motion and the value of the target pixel.
(4) The image processing apparatus according to any one of (1) to (4), wherein

the prediction coefficients are prediction coefficients previously learned by a learning apparatus, and

the learning apparatus includes:

a blur image generation part generating a blur image obtained by adding motion blur corresponding to a plurality of preset patterns of motion to the image captured by the image sensor; and

a coefficient calculation part calculating, corresponding to the respective plurality of patterns of motion, the prediction coefficients for calculating the prediction value of the target pixel in the captured image based on the values of the plurality of other pixels different from the target pixel in exposure time.
(5) An image processing method comprising:

calculating, with a calculation part, a prediction value of a target pixel in an image captured by an image capturing part capturing images using an image sensor configured by regularly arranging a plurality of pixels having a plurality of exposure times based on values of a plurality of other pixels different from the target pixel in exposure time and prediction coefficients corresponding to the respective other pixels; and

identifying, with a motion amount identifying part, a motion amount of the target pixel per unit time based on the calculated prediction value of the target pixel and a value of the target pixel.
(6) A program causing a computer to function as an image processing apparatus comprising:

a calculation part calculating a prediction value of a target pixel in an image captured by an image capturing part capturing images using an image sensor configured by regularly arranging a plurality of pixels having a plurality of exposure times based on values of a plurality of other pixels different from the target pixel in exposure time and prediction coefficients corresponding to the respective other pixels; and

a motion amount identifying part identifying a motion amount of the target pixel per unit time based on the calculated prediction value of the target pixel and a value of the target pixel.
(7) A recording medium in which the program according to (6) is stored.
(8) A learning apparatus comprising:

a blur image generation part generating a blur image obtained by adding motion blur corresponding to a plurality of preset patterns of motion to an image captured by an image capturing part capturing images using an image sensor configured by regularly arranging a plurality of pixels having a plurality of exposure times; and

a coefficient calculation part calculating, corresponding to the respective plurality of patterns of motion, prediction coefficients for calculating a prediction value of the target pixel in the captured image based on values of a plurality of other pixels different from the target pixel in exposure time.
(9) The learning apparatus according to (8), further comprising:

a prediction expression generation part generating a prediction expression for predicting a value of the target pixel based on the values of the plurality of other pixels in each blur image, wherein

the coefficient calculation part calculates values of coefficients by which the values of the plurality of other pixels are multiplied in the generated prediction expression as the prediction coefficients.
(10) The learning apparatus according to (8) or (9), further comprising:

a storage part storing the calculated prediction coefficients in association with the plurality of patterns of motion and positions of the plurality of other pixels.
(11) A learning method comprising:

generating, with a blur image generation part, a blur image obtained by adding motion blur corresponding to a plurality of preset patterns of motion to an image captured by an image capturing part capturing images using an image sensor configured by regularly arranging a plurality of pixels having a plurality of exposure times; and

calculating, with a coefficient calculation part, corresponding to the respective plurality of patterns of motion, prediction coefficients for calculating a prediction value of the target pixel in the captured image based on values of a plurality of other pixels different from the target pixel in exposure time.
(12) A program causing a computer to function as a learning apparatus comprising:

a blur image generation part generating a blur image obtained by adding motion blur corresponding to a plurality of preset patterns of motion to an image captured by an image capturing part capturing images using an image sensor configured by regularly arranging a plurality of pixels having a plurality of exposure times; and

a coefficient calculation part calculating, corresponding to the respective plurality of patterns of motion, prediction coefficients for calculating a prediction value of the target pixel in the captured image based on values of a plurality of other pixels different from the target pixel in exposure time.
(13) A recording medium in which the program according to (12) is stored.

The present disclosure contains subject matter related to that disclosed in Japanese Priority Patent Application JP 2011-155712 filed in the Japan Patent Office on Jul. 14, 2011, the entire content of which is hereby incorporated by reference.

What is claimed is:

1. An image processing apparatus comprising:
a calculation part calculating a prediction value of a target pixel in an image captured by an image capturing part capturing images using an image sensor configured by regularly arranging a plurality of pixels having a plurality of exposure times based on values of a plurality of other pixels different from the target pixel in exposure time and prediction coefficients corresponding to the respective other pixels; and
a motion amount identifying part identifying a motion amount of the target pixel per unit time based on the calculated prediction value of the target pixel and a value of the target pixel.

2. The image processing apparatus according to claim 1, further comprising:
a coefficient supply part supplying the prediction coefficients to the calculation part, wherein
the coefficient supply part supplies the prediction coefficients corresponding to a preset pattern of motion to the calculation part, and
the calculation part calculates the prediction value of the target pixel for each pattern of motion using a prediction expression based on the values of the plurality of other pixels and the prediction coefficients corresponding to the respective other pixels.

3. The image processing apparatus according to claim 1, wherein the motion amount identifying part identifies the motion amount of the target pixel per unit time based on a prediction error between the prediction value of the target pixel calculated for each preset pattern of motion and the value of the target pixel.

4. The image processing apparatus according to claim 1, wherein
the prediction coefficients are prediction coefficients previously learned by a learning apparatus, and
the learning apparatus includes:
a blur image generation part generating a blur image obtained by adding motion blur corresponding to a plurality of preset patterns of motion to the image captured by the image sensor; and
a coefficient calculation part calculating, corresponding to the respective plurality of patterns of motion, the prediction coefficients for calculating the prediction value of the target pixel in the captured image based on the values of the plurality of other pixels different from the target pixel in exposure time.

5. An image processing method comprising:
calculating, with a calculation part, a prediction value of a target pixel in an image captured by an image capturing part capturing images using an image sensor configured by regularly arranging a plurality of pixels having a plurality of exposure times based on values of a plurality of other pixels different from the target pixel in exposure time and prediction coefficients corresponding to the respective other pixels; and
identifying, with a motion amount identifying part, a motion amount of the target pixel per unit time based on the calculated prediction value of the target pixel and a value of the target pixel.

6. A program causing a computer to function as an image processing apparatus comprising:
a calculation part calculating a prediction value of a target pixel in an image captured by an image capturing part capturing images using an image sensor configured by regularly arranging a plurality of pixels having a plurality of exposure times based on values of a plurality of other pixels different from the target pixel in exposure time and prediction coefficients corresponding to the respective other pixels; and
a motion amount identifying part identifying a motion amount of the target pixel per unit time based on the calculated prediction value of the target pixel and a value of the target pixel.

7. A recording medium in which the program according to claim 6 is stored.

8. A learning apparatus comprising:
a blur image generation part generating a blur image obtained by adding motion blur corresponding to a plurality of preset patterns of motion to an image captured by an image capturing part capturing images using an image sensor configured by regularly arranging a plurality of pixels having a plurality of exposure times; and
a coefficient calculation part calculating, corresponding to the respective plurality of patterns of motion, prediction coefficients for calculating a prediction value of the target pixel in the captured image based on values of a plurality of other pixels different from the target pixel in exposure time.

9. The learning apparatus according to claim 8, further comprising:
a prediction expression generation part generating a prediction expression for predicting a value of the target pixel based on the values of the plurality of other pixels in each blur image, wherein
the coefficient calculation part calculates values of coefficients by which the values of the plurality of other pixels are multiplied in the generated prediction expression as the prediction coefficients.

10. The learning apparatus according to claim 8, further comprising:
a storage part storing the calculated prediction coefficients in association with the plurality of patterns of motion and positions of the plurality of other pixels.

11. A learning method comprising:
generating, with a blur image generation part, a blur image obtained by adding motion blur corresponding to a plurality of preset patterns of motion to an image captured by an image capturing part capturing images using an image sensor configured by regularly arranging a plurality of pixels having a plurality of exposure times; and
calculating, with a coefficient calculation part, corresponding to the respective plurality of patterns of motion, prediction coefficients for calculating a prediction value of the target pixel in the captured image based on values of a plurality of other pixels different from the target pixel in exposure time.

12. A program causing a computer to function as a learning apparatus comprising:
a blur image generation part generating a blur image obtained by adding motion blur corresponding to a plurality of preset patterns of motion to an image captured by an image capturing part capturing images using an image sensor configured by regularly arranging a plurality of pixels having a plurality of exposure times; and
a coefficient calculation part calculating, corresponding to the respective plurality of patterns of motion, prediction coefficients for calculating a prediction value of the target pixel in the captured image based on values of a plurality of other pixels different from the target pixel in exposure time.

13. A recording medium in which the program according to claim 12 is stored.
